(19) United States
(12) Patent Application Publication
(10) Pub. No.: US 2007/0183476 A1
(43) Pub. Date: Aug. 9, 2007

(54) Low temperature alert system

(76) Inventor: William H. Marschner, Cranbrook (CA)

Correspondence Address: JAMES RAY & ASSOCIATES, 2640 PITCAIRN ROAD, MONROEVILLE, PA, 15146, US

(21) Appl. No.: 11/656,924

(22) Filed: Jan. 23, 2007

Related U.S. Application Data
(60) Provisional application No. 60/765,782, filed on Feb. 7, 2006.

(51) Int. Cl. G01K 1/14; G01K 1/08

(52) U.S. Cl. 374/152; 374/141; 236/DIG. 3

(57) ABSTRACT

An electrical device for providing a visual alert to one of a neighbor and a home sitter that the temperature of the home has dropped below a predetermined temperature when a homeowner is absent. The device comprises a plug in unit for plugging into a standard three prong wall circuit. The plug in unit is designed to control three separate circuits. A solid state thermostat is disposed within the plug in unit, such thermostat having a preset temperature for activation. A switch is electrically connected to such thermostat for triggering a first circuit of such three separate circuits to turn off and for activating a second circuit and a third circuit of such three separate circuits when the temperature drops below the preset temperature. A lighted means is connected to the switch and the plug in unit for providing a visual alert when one of the temperature drops below the preset temperature or in an event of a power failure.

### CROSS REFERENCE TO RELATED APPLICATIONS

This application is closely related to and claims benefit from U.S. Provisional Application Ser. No. 60/765,782 filed Feb. 7, 2006.

### FIELD OF THE INVENTION

The present invention relates, in general, to a temperature warning device, and, more particularly, the present invention relates to a low temperature alerting system that produces a visual notification in the case of a heating system failure in an unoccupied home.

### BACKGROUND OF THE INVENTION

Individuals who may travel for work or for pleasure for extended periods of time, such as weeks or months, often rely on a neighbor or house sitter to periodically check on their home during such absence for potential problems. One such problem could be a heating system failure which would be very important for homes that are in the northern areas since the winter temperatures can very often dip below freezing for extended periods of time. A furnace failure in these instances may result in damage to the home and to utilities as water lines can freeze. The damages caused be frozen water lines can result in very costly repairs. Many modern heating systems vent out of the side of the house. In most cases this decreases the visibility of proper operation of furnaces since the furnace vapors are not very evident and, thus, increases the need for a more easily observed visual alerting system in the event of failure.

Thus, it would be advantageous if there were a means available whereby a visual alert that would be visible to home sitter or a neighbor if the home temperature dropped below a specified temperature when the homeowner was away.

### SUMMARY OF THE INVENTION

In a first aspect the present invention provides an electrical device for providing a visual alert to one of a neighbor and a home sitter that the temperature of the home has dropped below a predetermined temperature when a homeowner is absent. The device comprises a plug in unit for plugging into a standard three prong wall circuit. The plug in unit is designed to control three separate circuits. A solid state thermostat is disposed within the plug in unit, such thermostat having a preset temperature for activation. A switch means is electrically connected to such thermostat for triggering a first circuit of such three separate circuits to turn off and for activating a second circuit and a third circuit of such three separate circuits when the temperature drops below the preset temperature. A means is connected to the switch and the plug in unit for providing a visual alert when one of the temperature drops below the preset temperature or in an event of a power failure.

### OBJECTS OF THE INVENTION

It is, therefore, one of the primary objects of the present invention is to provide a device for alerting a designated neighbor or home sitter of a furnace problem.

Another object of the present invention is to provide a device for alerting a designated neighbor or home sitter by a visual means.

Still another object of the present invention is to provide a device for alerting a designated neighbor or home sitter of the possibility of a power failure.

Yet another object of the present invention is to provide a device for alerting a designated neighbor or home sitter with a visual means that is relatively inconspicuous.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the front side of a plug-in unit showing the outlets for the three circuits that are available for use with this device.

FIG. 2 is a perspective view of the inside of the plug-in unit shown in FIG. 1 showing the simple wiring for connecting to the three circuits, a first circuit is active above the preset temperature and the second and third circuits are deactivated, the second and third circuits are activated at the preset temperature with the first circuit being deactivated.

FIG. 3 is a perspective view of the back side of the plug-in unit shown in FIG. 1 as it plugs into a three prong wall socket.

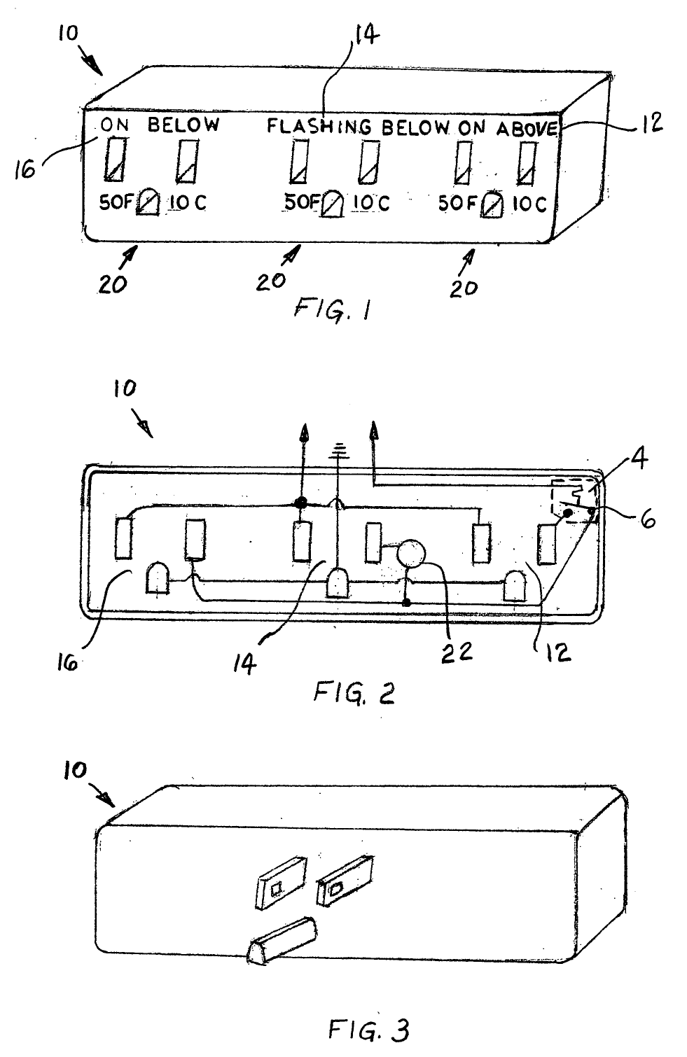

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an electrical device, generally designated 10, for providing a visual alert to one of a neighbor and a home sitter that the temperature of the home has dropped below a predetermined temperature when a homeowner is absent. The device 10 comprises a plug in unit 2 for plugging into a standard three prong wall circuit. The plug in unit 2 is designed to control three separate circuits. A solid state thermostat 4 is disposed within the plug in unit 10, such thermostat 4 having a preset temperature for activation. A switch means 6 is electrically connected to such thermostat 4 for triggering a first circuit 12 of such three separate circuits to turn off and for activating a second circuit 14 and a third circuit 16 of such three separate circuits when the temperature drops below the preset temperature. A means, generally designated 20, is connected to the plug in unit 2 (and thus also controlled by switch 6) for providing a visual alert when the temperature drops below the preset temperature or in an event of a power failure.

Such means for providing a visual alert includes at least one lighted member. Such lighted member is at least one of a lamp, an outside light and a flasher 22. Each of these lighted members units merely plug into one of the three outlets that are on the plug in unit 10. The plug in unit 10 resembles a standard three-outlet multi plug adapter.

The first circuit 12 of the three separate circuits is connected to a light which stays on unless one of the temperature drops below the preset temperature or in the event of a power failure. Having such light, which could be just a lamp, that is programmed to be always on when viewed by such home sitter or neighbor as being unlit alerts such neighbor or such home sitter that there is a problem, either one of a furnace problem or a power failure.

Such second circuit 14 or such third circuit 16 are connected so as to activate one of a flashing light with one circuit and the other one of such second circuit or said third circuit is connected to activate a less conspicuous non-flashing light so to alert such neighbor and such home sitter of a furnace problem. By having the light be a non flashing light, possibly a porch light or a back door light, while still able to alert the neighbor or home sitter that there is a problem with the furnace and that the temperature has dropped below the preset temperature is much less conspicuous and so will not attract attention to the fact that the owner is not at home. The flashing light could be an internal light that might be visible from a window. As illustrated in FIG. 2 such first circuit 12 is set up to be on unless the temperature drops below 50 degrees Fahrenheit or if there is a power failure. The second circuit 14 is set up to be connected to a flasher 22, while the third circuit 16 is set up to be connected to another visual device, possibly a porch light. Both the second circuit 14 and third circuit 16 are set up to be activated in the temperature drops below the preset temperature. The circuits could be arranged in a different order but the system would basically be the same with one on and two off unless the temperature drops to the preset temperature. Although there are three separate circuits in the plug in unit the homeowner may decide to only utilize one of the circuits or possibly two depending on his/her choice. It may be a decision based on who is watching the home whether it is a neighbor or a drive by home sitter. The selection may be based on what is most convenient for the home sitter or neighbor.

The switch means is part of the thermostat 4 and is a flip/flop switch similar to switches in standard thermostats that control a furnace or an air conditioner's operation. The preset temperature is generally preset at 50 degrees Fahrenheit (or 10 degrees Celsius.). However, it is within the scope of the invention that such preset temperature can be set at any predetermined temperature by such homeowner.

Thus, the present invention provides an electrical plug in device that can be used by homeowners to create a visual alert in the event that the home temperature has dropped below a predetermined temperature when the homeowner is away. The plug in device utilizes a solid-state thermostat to control a flip flop switch. The switch is basically the same as the switch on a regular home thermostat which activates the furnace to come on when directed by the thermostat temperature reading. The switch in this case will trigger a first circuit to turn off and will activate the other two circuits when the temperature drops below the preset temperature. The first circuit is normally on and is turned off when the temperature drops below the preset temperature. The first circuit could be connected to a light which would always be on and possibly visible from the outside so as to be readily noticed by a neighbor or a drive by home sitter. Thus, if the light is on there is no problem but if the light is off then home sitter or neighbor knows there is a problem with either a power failure or the temperature has dropped below the preset temperature.

One of the second or third circuits could have a light that is plugged into the device that would flash to alert house sitters or neighbors of a heating system failure. The other circuit could have a less conspicuous non-flashing light that could be used to alert a neighbor or house sitter of the problem. The neighbor or home sitter that is watching the home while the owners are away will know instantly whether the home is prone to damage due to a furnace problem and may enter the home or call for assistance at once if these alert signals are recognized. A “Normally On” circuit, such as described above for the first circuit, could be used if the preference is to leave a light on when the individual is away from home. The consumer can simply plug a standard lamp into this location. The feature would provide an alert of both a power failure and a heating system failure.

It should be noted that all switches and wiring are enclosed within the plug in unit. A solid state thermostat switches the flip/flop switch at 50 degrees Fahrenheit or to whatever the preset temperature is. As shown in FIG. 2 the left contact on the flip/flop switch is energized if the temperature is above 50 degrees, while the right contact is energized if the temperature drops below the preset temperature (50 degrees F. in most cases).

The simple plug in device can be utilized as a standard outlet as well. The size and appearance of the “Low Temperature Alert” can be similar to a three-outlet multi plug adapter. The unit can be tested by placing it into a refrigerator for a short period of time and plugging a light into the appropriate socket to ensure proper operation.

The low temperature alert system was developed to offer a quick visual indication that the home temperature has dropped below 50 degrees Fahrenheit. The “Low Temperature Alert” can provide a subtle alert enabling any designated neighbor or drive by home sitter to be made visually aware of a possible power failure or of a home heating system failure without drawing attention to the fact that the homeowner is not present. Every home situated in regions that dip below freezing temperatures can benefit from the device. This is an easy solution designed to increase the protection of the home of any absent homeowner.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. An electrical device for providing a visual alert to one of a neighbor and a home sitter that a temperature of such home has dropped below a predetermined temperature when a homeowner is absent, said device comprising:
(a) a plug in unit for plugging into a standard three prong wall circuit, said plug in unit designed to control three separate circuits;
(b) a solid state thermostat disposed within said plug in unit, said thermostat having a preset temperature for activation;
(c) a switch electrically connected to said thermostat for triggering a first circuit of said three separate circuits to turn off and for activating a second circuit and a third circuit of said three separate circuits when said temperature drops below said preset temperature; and
(d) a means connected to said switch and said plug in unit for providing a visual alert when one of said temperature drops below said preset temperature and in an event of a power failure.

2. The electrical device, according to claim 1 wherein said means for providing a visual alert includes at least one lighted member.

3. The electrical device, according to claim 2 wherein said lighted member is one of a lamp, an outside light and a flasher.

4. The electrical device, according to claim 1 wherein said first circuit of said three separate circuits is connected to a light which stays on unless one of said temperature drops below said preset temperature and a power failure, having said light unlit alerts such neighbor and such home sitter that there is one of a furnace problem and a power failure.

5. The electrical device, according to claim 1 wherein one of said second circuit and said third circuit are connected so as to activate one of a flashing light and another one of said second circuit and said third circuit is connected to activate a less conspicuous non-flashing light to alert such neighbor and such home sitter of a furnace problem.

6. The electrical device, according to claim 1 wherein said switch is a flip-flop switch in said thermostat.

7. The electrical device, according to claim 1 wherein said preset temperature is one of 50 degrees Fahrenheit and 10 degrees Celsius.

8. The electrical device, according to claim 1 wherein said preset temperature can be set at any predetermined temperature by such homeowner.
